(19) United States
(12) Patent Application Publication
(10) Pub. No.: US 2024/0243259 A1
(43) Pub. Date: Jul. 18, 2024

(54) NICKEL-RICH ELECTROACTIVE MATERIALS

(71) Applicant: GM GLOBAL TECHNOLOGY OPERATIONS LLC, Detroit, MI (US)

(72) Inventors: Mengyuan CHEN, Madison Heights, MI (US); Zhongyi LIU, Troy, MI (US); Bradley R. FRIEBERG, Farmington Hills, MI (US); Xiaosong HUANG, Novi, MI (US); Nicholas Paul William PIECZONKA, Windsor, Ontario (CA)

(73) Assignees: GM GLOBAL TECHNOLOGY OPERATIONS LLC, Detroit, MI (US); GM GLOBAL TECHNOLOGY OPERATIONS LLC, Detroit, MI (US)

(21) Appl. No.: 18/094,163

(22) Filed: Jan. 6, 2023

(51) Int. Cl. H01M 4/36; C01G 53/00; H01M 4/505; H01M 4/525

(52) U.S. Cl. CPC H01M 4/366; C01G 53/50; H01M 4/505; H01M 4/525; C01P 2002/54; C01P 2004/86; C01P 2006/40

(57) ABSTRACT

An electroactive material for an electrochemical cell includes one or more conductive oxygen storage material coatings or layers. The electroactive material includes a plurality of electroactive material particles disposed to form an electroactive material layer. In certain variations, at least a portion of the plurality of electroactive material particles may have a coating that includes a conductive oxygen storage material. In other variations, a conductive oxygen storage material layer may be disposed on one or more surfaces of the electroactive material layer. In still other variations, at least a portion of the plurality of electroactive material particles may have a coating that includes a conductive oxygen storage material, and a conductive oxygen storage material layer may be disposed on one or more surfaces of the electroactive material layer. The one or more conductive oxygen storage material coatings or layers may help to improve the thermal stability of the electroactive materials.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes include nickel-rich electroactive materials (e.g., having greater than or equal to about 0.6, and in certain variations, optionally about 0.8, mole fraction on transition metal lattice), such as NMC (LiNi_{1-x-y}CoₓMn_{y}O₂) (where 0.01≤x≤0.33,0.01≤y≤0.33) or NCMA (LiNi_{1-x-y-z}COₓMn_{y}Al₂O₂) (where 0.02≤x≤0.20,0.01≤y≤0.12,0.01≤z≤0.08), which are capable of providing improved capacity capability (e.g., greater than 200 mAh/g) while allowing for additional lithium extraction without compromising the structural stability of the positive electrode. Such materials, however, often decompose at low temperatures (e.g., below 300° C.), generating oxygen and boosting various exothermal side reactions within the cell, which can result in thermal propagation and/or runaway. Accordingly, it would be desirable to develop improved active materials, and methods of making and using the same, that can address these challenges.

### SUMMARY

This section provides a general summary of the disclosure, and is not a comprehensive disclosure of its full scope or all of its features.

The present disclosure relates to nickel-rich electroactive materials and to methods of making and using the same. The nickel-rich electroactive materials may include one or more conductive oxygen storage material coatings or layers. The one or more conductive oxygen storage material coatings or layers may help to improve the thermal stability of the nickel-rich electroactive materials.

In various aspects, the present disclosure provides an electroactive material for an electrode of an electrochemical cell. The electroactive material may include a plurality of electroactive material particles, where at least a portion of the plurality of electroactive material particles have a coating that includes a conductive oxygen storage material. The conductive oxygen storage material may have a lithium diffusion coefficient greater than or equal to about 10⁻¹⁵ cm²·s.

In one aspect, the electroactive material may include greater than 0 wt. % to less than or equal to about 10 wt. % of the plurality of electroactive material particles having the coating.

In one aspect, the conductive oxygen storage material may be selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

In one aspect, the electroactive material particles may include a nickel rich electroactive material represented by:

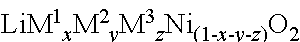

where M¹, M², and M³ are each a transition metal independently selected from the group consisting of: manganese (Mn), cobalt (Co), aluminum (Al), iron (Fe), and combinations thereof, where 0≤x≤1, 0≤y≤1, and 0≤z≤1 and 1-x-y-z is greater than 0.6

In one aspect, the coating may be a continuous coating covering, for example, greater than or equal to about 85% of a total surface area of the respective electroactive material particles.

In one aspect, the coating may have an average thicknesses greater than 2 nanometers to less than or equal to about 200 nanometers

In various aspects, the present disclosure provides an electrode for an electrochemical cell. The electrode may include an electroactive material layer that includes a plurality of electroactive material particles, and a conductive layer that includes an oxygen storage material and has a lithium diffusion coefficient greater than or equal to about 10-15 cm²·s disposed on one or more surfaces of the electroactive material layer.

In one aspect, the electrode may include greater than 0 wt. % to less than or equal to about 10 wt. % of the oxygen storage material.

In one aspect, the oxygen storage material may be selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

In one aspect, the electroactive material particles may include a nickel rich electroactive material represented by:

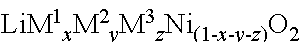

where M⁴ is nickel and M¹, M², and M³ are each a transition metal independently selected from the group consisting of: manganese (Mn), cobalt (Co), aluminum (Al), iron (Fe), and combinations thereof, where 0≤x≤1, 0≤ y≤1, and 0≤z≤1 and 1-x-y-z is greater than 0.6.

In one aspect, the conductive layer may be a continuous layer covering greater than or equal to about 85% of a total surface area of the respective surfaces of the electroactive material layer.

In one aspect, the conductive layer may have an average thickness greater than 2 nanometers to less than or equal to about 200 nanometers.

In one aspect, the oxygen storage material may be a first oxygen storage material and at least a portion of the electroactive material particles may be coated with a second oxygen storage material.

In one aspect, the second oxygen storage material may define particle coatings on the portion of the electroactive material particles. The particle coatings may have average thicknesses greater than 2 nanometers to less than or equal to about 200 nanometers.

In one aspect, the second oxygen storage material may define particle coatings on the portion of the electroactive material particles. The particle coatings may be continuous coatings covering greater than or equal to about 85% of a total surface area of the respective electroactive material particles.

In one aspect, the second oxygen storage material may be selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

In one aspect, the second oxygen storage material may be the same as the first oxygen storage material.

In various aspects, the present disclosure provides an electrode for an electrochemical cell. The electrode may include an electroactive material layer that includes a plurality of electroactive material particles. The electroactive material particles of the plurality may include a nickel rich electroactive material represented by:

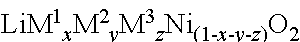

where M¹, M², and M³ are each a transition metal independently selected from the group consisting of: manganese (Mn), cobalt (Co), aluminum (Al), iron (Fe), and combinations thereof, where 0≤ x≤1, 0≤ y≤1, and 0≤z≤1 and 1-x-y-z is greater than 0.6.Aat least a portion of the plurality of electroactive material particles may include a particle coating that includes a first conductive oxygen storage material. The electrode may also include a conductive layer that includes a second conductive oxygen storage material disposed on one or more surfaces of the electroactive material layer. The first and second conductive oxygen storage materials may each have a lithium diffusion coefficient greater than or equal to about 10-15 cm²·s.

In one aspect, the first and second conductive oxygen storage materials are independently selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

In one aspect, the electrode may include less than or equal to about 10 wt. % of the first conductive oxygen storage material, and less than or equal to about 10 wt. % of the second conductive oxygen storage material.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein is for illustrative purposes only of selected embodiments and not all possible implementations, and is not intended to limit the scope of the present disclosure.

FIG. 1 is an illustration of an example electrochemical cell including an electroactive material layer including one or more conductive oxygen storage material coatings or layers in accordance with various aspects of the present disclosure;

FIG. 2 is an illustration of an example electroactive material layer including conductive oxygen storage material particle coatings in accordance with various aspects of the present disclosure;

FIG. 3 is an illustration of an example electroactive material layer including conductive oxygen storage material layer coatings in accordance with various aspects of the present disclosure;

FIG. 4 is an illustration of an example electroactive material layer including conductive oxygen storage material particle and layer coatings in accordance with various aspects of the present disclosure;

FIG. 5 is a graphical illustration demonstrating the thermal stability of an example cell including a nickel-rich electroactive material and one or more conductive oxygen storage material coatings or layers in accordance with various aspects of the present disclosure; and

FIG. 6 is a graphical illustration demonstrating the resistance of an example cell including a nickel-rich electroactive material and one or more conductive oxygen storage material coatings or layers in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

The present disclosure relates to electroactive materials including a coating or layer comprising one or more conductive oxygen storage materials, also referred to herein as conductive oxygen storage material coatings or layers. The one or more conductive oxygen storage material coatings or layers help to improve the thermal stability of the electroactive materials. Although the following discussion is directed to lithium-ion electrochemical cells that cycle lithium ions, it should be appreciated that similar teachings also apply to calcium-ion electrochemical cells that cycle calcium ions, sodium-ion electrochemical cells that cycle sodium ions, and/or potassium-ion electrochemical cells that cycle potassium ions. In each instance, the electrochemical cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

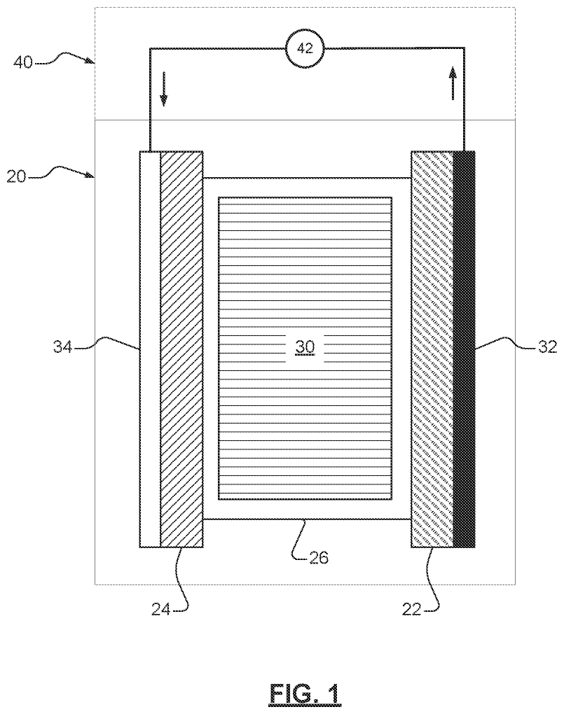

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 may include an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may include a plurality of solid-state electrolyte particles and/or a gel electrode. The negative electrode 22 and/or the positive electrode 24 may additionally or alternatively include a plurality of solid-state electrolyte particles and/or a gel electrolyte. The solid-state electrolyte particles and/or gel electrolyte as included in, or defining, the separator 26 may be the same as or different from the solid-state electrolyte particles and/or gel electrode included in the positive electrode 24 and/or the negative electrode 22, and the solid-state electrolyte particles and/or gel electrolyte as included in the positive electrode 24 may be the same as or different from the solid-state electrolyte particles and/or gel electrolyte as included in negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode (which can also be referred to as a positive electroactive material layer) 24. The second current collector 34 together with the positive electrode 24 may be referred to as a positive electrode assembly. Although not illustrated, the skilled artisan will appreciate that, in certain variations, positive electroactive material layer 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24, may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiCIO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separators 26 include CELGARD® 2500 (a monolayer polypropylene separator)) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous member having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. For example, in certain variations, the separator 26 may be a polyolefin-based separator including, for example, polyacetylene, propylene (PP), and/or polyethylene (PE); a cellulose separator including, for example, polyvinylidene fluoride (PVDF) member and/or a porous polyimide member; and/or a high-temperature-stable separators including, for example, polyimide (PI) nanofiber-based nonwoven members, nano-sized aluminum oxide (Al₂O₃) and poly(lithium 4-styrenesulfonate)-coated polyethylene members silicon oxide (SiO₂) coated polyethylene (PE) members, co-polyimide-coated polyethylene members, polyetherimides (PEI) (bisphenol-aceton diphthalic anhydride (BPADA) and para-phenylenediamine) members, expanded polytetrafluoroethylene reinforced polyvinylidenefluoride-hexafluoropropylene members, and/or sandwiched-structure polyvinylidene fluoride (PVDF)-poly(m-phenylene isophthalamide) (PMIA)-polyvinylidene fluoride (PVDF) members. In each instance, the separator 26 may have an average thickness greater than or equal to about 1 micrometer (μm) to less than or equal to about 50 μm, and in certain instances, optionally greater than or equal to about 1 μm to less than or equal to about 20 μm; and the electrolyte 30 may wet greater than or equal to about 5 vol. % to less than or equal to about 100 vol. %, of a total porosity of the separator 26.

In various aspects, the porous separator 26 and/or the electrolyte 30 disposed in the porous separator 26 as illustrated in FIG. 1 may be replaced with a solid-state electrolyte (“SSE”) and/or semi-solid electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24.

The solid-state electrolyte and/or semi-solid electrolyte may include a plurality of solid-state electrolyte particles. In certain variations, the electrolyte 30 may at least partially fill voids (e.g., interparticle porosity) between the solid-state electrolyte particles defining the separator 26. In each variation, the solid-state electrolyte particles may include, for example, oxide-based solid-state particles (such as garnet type solid-state particles (e.g., Li₇La₃Zr₂O₁₂ (LLZO)), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤ x≤2) (LAGP)), and/or LISICON type solid-state particles (e.g., Li₂₊₂ₓZn₁₋ₓGeO₄, where 0<x<1)), metal-doped or aliovalent-substituted oxide solid-state particles (such as aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{y}P_{3-y}O₁₂ (where 0<x<2 and 0<y <3)), sulfide-based solid-state particles (such as Li₂S-P₂S₅ systems (e.g., Li₃PS₄, Li₇P₃S₁₁, and Li_{9.6}P₃S₁₂), Li₂S-SnS₂ systems (e.g., Li₄SnS₄), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₂P₃S₁₁, LigP₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(S_{10.5}Ge_{0.5})P₂S₁₂, Li₁₀(Ge_{0.5}Sn_{0.5})P₂S₁₂, Li₁₀(S_{10.5}Sn_{0.5})P₂S₁₂, Li_{3.933}Sn_{0.833}AS_{0.166}S₄, LiI-Li₄SnS₄, and/or Li₄SnS₄), nitride-based solid-state particles (such as Li₃N, Li₂PN₄, and/or LiSi₂N₃), hydride-based solid-state particles (such as LiBH₄, LiBH₄-LiX (where X=Cl, Br, or I), LiNH₂, Li₂NH, LiBH₄-LiNH₂, and/or Li₃AlH₆), halide-based solid-state particles (such as Li₃YCl₆, Li₃InCl₆, Li₃YBr₆, LiI, Li₂CdCl₄, Li₂MgCl₄, LiCdl₄, Li₂Znl₄, and/or Li₃OCI), and/or borate-based solid-state particles (Li₂B₄O₇ and/or Li₂O-B₂O₃-P₂O₅).

The semi-solid electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The liquid electrolyte may be like the electrolyte 30 detailed above. In certain variations, the semi-solid or gel electrolyte may also be found in the negative electrode 22 and/or positive electrode 24.

The negative electrode 22 is formed from a lithium host material that is capable of functioning as a negative terminal of a lithium-ion battery. In various aspects, the negative electrode 22 may be defined by a plurality of negative electroactive material particles. The negative electroactive material particles may be disposed in one or more layers so as to define the three-dimensional structure of the negative electrode 22. The electrolyte 30 may be introduced, for example after cell assembly, and contained within pores of the negative electrode 22 (i.e., within voids or spaces between the negative electroactive material particles). In certain variations, the negative electrode 22 may include a plurality of solid-state electrolyte particles dispersed with the negative electroactive material particles. The electrolyte 30 may at least partially file voids or spaces between the negative electroactive material particles and the solid-state electrolyte particles. In each instance, the negative electrode 22 may have an average thickness greater than or equal to about 30 μm to less than or equal to about 500 μm, and in certain aspects, optionally greater than or equal to about 50 μm to less than or equal to about 100 μm.

In certain variations, the negative electroactive material particles may include silicon-containing (or silicon-based) electroactive materials. The silicon-containing electroactive materials may include silicon, lithium-silicon alloys, and other silicon-containing binary and/or ternary alloys. For example, in certain variations, the silicon-containing electroactive material may include elemental silicon (Si), various lithium silicide phases (LiₓSi_{y}, where 0<x<17 and 1<y<4), silicon nanograins embedded in a silicon oxide (SiOₓ, where 0<x<2) matrix, lithium doped silicon oxide (Li_{y}SiOₓ, where 0<x<2 and 0<y<1), and combinations thereof. The silicon-containing electroactive materials may be provided as nano-particles, nano-fibers, nano-tubes, and/or micro-particles.

In other variations, the negative electrode 22 may include one or more other alloying anode materials such as aluminum, germanium, tin, antimony, and/or bismuth). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In still other variations, the negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be a alloying anode material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 weight percent (wt. %) SiOₓ (where 0≤ x≤2) and about 90 wt. % graphite.

In each variation, the negative electroactive material may be optionally intermingled with an electronically conductive material (i.e., conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24 (i.e., within voids or spaces between the positive electroactive material particles). In certain variations, the positive electrode 24 may include a plurality of solid-state electrolyte particles dispersed with the positive electroactive material particles. The electrolyte 30 may at least partially fill voids or spaces between the positive electroactive material particles and the solid-state electrolyte particles. In each instance, the positive electrode 24 may have an average thickness greater than or equal to about 30 μm to less than or equal to about 500 μm, and in certain aspects, optionally greater than or equal to about 50 μm to less than or equal to about 100 μm.

In certain variations, the positive electrode 24 may be a nickel-rich cathode including a nickel-rich positive electroactive material. The nickel-rich positive electroactive material may comprise greater than or equal to about 60 molar percent, and in certain aspects, optionally 80 molar percent, of nickel. In certain aspects, the electroactive material may be represented by the formula:

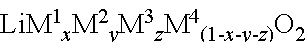

where M¹, M², M³, and M⁴ are each a transition metal (for example, each is independently selected from the group consisting of: nickel (Ni), manganese (Mn), cobalt (Co), aluminum (Al), iron (Fe), and combinations thereof), where 0≤ x≤1, 0≤ y≤1, and 0≤ z≤1. For example, M⁴ may include nickel (Ni), so that the nickel-rich positive electroactive material is represented by the formula:

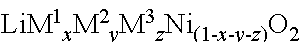

where M¹, M², and M³ are independently selected from the group consisting of: manganese (Mn), cobalt (Co), aluminum (Al), iron (Fe), and combinations thereof, where 1-x-y-z is such that the nickel (Ni) content is greater than or equal to about 60 molar percent, and in certain aspects, optionally greater than or equal to about 80 molar percent. In certain variations, the nickel-rich positive electroactive material may include

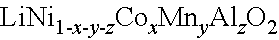

where 0.02≤x≤0.20,0.01≤y≤0.12,0.01≤z≤0.08. Further still, in certain variations, the positive electrode 24 may include, additionally or alternatively, NMC (LiNiₓCo_{y}Mn_{1-x-y}O₂, where 0.8≤ x≤1, 0≤y≤0.4) and/or NCA (LiNiₓCo_{y}Al_{1-x-y}O₂, where 0.8≤ x≤1, 0≤y≤0.4) and/or NCMA (LiNiₓCo_{y}Mn₂Al_{1-x-y-2}O₂, where 0.8≤ x ≤1, 0≤ y≤0.4, 0≤ z≤0.4).

In other variations, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a favorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still other variations, the positive electrode 24 may be a composite electrode including two or more positive electroactive material. For example, the positive electrode 24 may include a first positive electroactive material and a second positive electroactive material. In certain variations, a mass ratio of the first positive electroactive material to the second positive electroactive material may be greater than or equal to about 1:9 to less than or equal to about 9:1. The first positive electroactive material may include the nickel-rich positive electroactive material. The second positive electroactive material may include, for example, a layered oxide represented by LiMeO₂, where Me is a transition metal, such as cobalt (Co), nickel (Ni), manganese (Mn), iron (Fe), aluminum (Al), vanadium (V), or combinations thereof; an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; and/or a favorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still other variations, the positive electroactive material may be selected from the group consisting of: LiNiₓCo_{y}Mn_{1-x-y}O₂ where 0.6≤ x≤1 and 0≤y ≤0.4 (e.g., NCM), LiNiₓCo_{y}Al_{1-x-y}O₂ where 0.6≤ x≤1 and 0≤ y≤0.4 (e.g., NCA), LiNiₓCo_{y}Mn_{z}Al_{1-x-y-2}O₂ where 0.6≤x≤1, 0≤y≤0.4, and 0≤z≤0.4(e.g., NCMA), LiNiO₂ (LNO), LiCoO₂ (LCO), LiNi_{0.5}Mn_{1.5}O₄ (LNMO), LiMnPO₄ (LMP), LiCoPO₄ (LCP), xLi₂MnO₃·(1-x)LiTMO₂ (TM=Mn, Ni, and Co etc., 0<x<1), and combinations thereof.

In each variation, the positive electroactive material including one or more conductive oxygen storage material coatings or layers that help to improve the stability of the positive electroactive material. For example, the conductive oxygen storage material is selected to store and release oxygen and as such the conductive oxygen storage material coatings or layers may help to stabilize the positive electroactive material by limiting reaction of oxygen with the electrolyte 30. Further, the conductive oxygen storage material may help to improve the cycle stability of the positive electroactive material by stabilizing the crystal structure. The lithium-ion conductivity of the conductive oxygen storage material coatings or layers may also facilitate electron transfer thus reducing or limiting the required carbon in the cell.

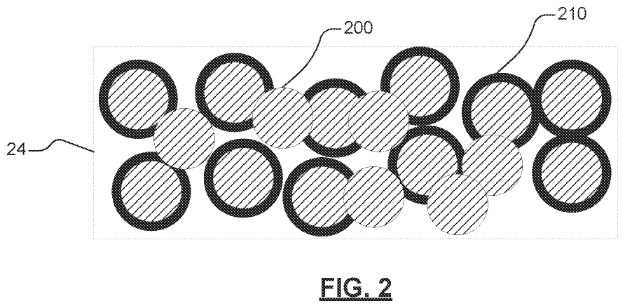

In certain variations, as illustrated in FIG. 2, the conductive oxygen storage material may be provided in the form of particle coatings 210 that coat at least a portion of the plurality of positive electroactive material particles 200. Although illustrate as continuous coatings covering greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total surface area of the respective positive electroactive material particles 200, it should be recognized that, in certain variations, the particle coatings 210 may be discontinuous coatings covering any portion of the positive electroactive material particles 200. In each instance, the particle coatings 210 may have an average thickness greater than 0 nanometers (nm) to less than or equal to about 200 nanometers, and in certain aspects, optionally greater than or equal to about 2 nanometers to less than or equal to about 200 nanometers. The positive electrode 24 including the particle coatings 210 may include greater than 0 wt. % to less than or equal to about 10 wt. %, optionally greater than or equal to about 0.01 wt. % to less than or equal to about 10 wt. %, and in certain aspects, optionally greater than or equal to about 0.01 wt. % to less than or equal to about 5 wt. %, of the conductive oxygen storage material, while the remainder of the positive electroactive material particles 200 remain uncoated.

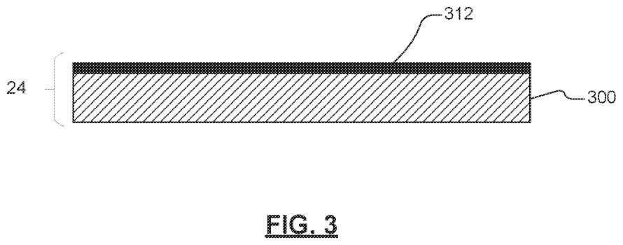

In other variations, as illustrated in FIG. 3, the conductive oxygen storage material may be provided in the form of a layer coating 312 that coats at least a portion of a surface area of a positive electroactive material layer 300. Although illustrated as a continuous coating covering greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total surface area of the positive electroactive material layer 300, it should be recognized that, in certain variations, the layer coating 312 may be a discontinuous layer coating covering any portion of the positive electroactive material layer 300. In each instance, the layer coating 312 may have an average thickness greater than 0 nanometer to less than or equal to about 200 nanometers, and in certain aspects, optionally greater than or equal to about 2 nanometers to less than or equal to about 200 nanometers. The positive electrode 24 including the layer coating 312 may include greater than 0 wt. % to less than or equal to about 10 wt. %, optionally greater than or equal to about 0.01 wt. % to less than or equal to about 10 wt. %, and in certain aspects, optionally greater than or equal to about 0.01 wt. % to less than or equal to about 5 wt. %, of the conductive oxygen storage material.

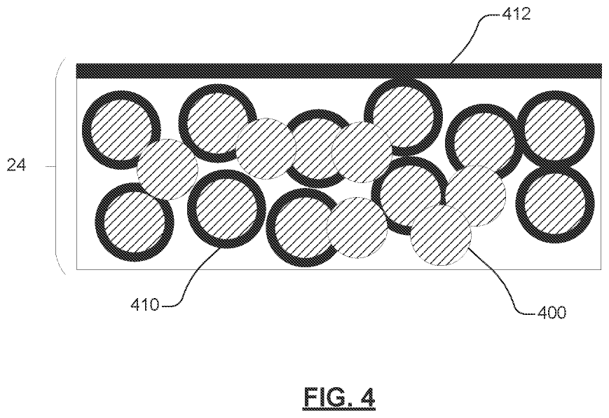

In still further variations, as illustrated in FIG. 4, the conductive oxygen storage material may include a combination of particle coatings 410 that coat at least a portion of the plurality of positive electroactive material particles 400 and a layer coating 412 that coats at least a portion of a surface area of a positive electroactive material layer 400. Like the particle coating 210 illustrated in FIG. 2, the particle coating 410 may be a continuous or discontinuous particle coating and may have an average thickness greater than 0 nanometer to less than or equal to about 200 nanometers, and in certain aspects, optionally greater than or equal to about 2 nanometers to less than or equal to about 200 nanometers. Like the layer coating 312 illustrated in FIG. 3, the layer coating 412 may be a continuous or discontinuous layer coating and may have an average thickness greater than 0 nanometer to less than or equal to about 200 nanometers, and in certain aspects, optionally greater than or equal to about 2 nanometers to less than or equal to about 200 nanometers. The positive electrode 24 including the particle coating 410 and the layer coating 412 may include greater than 0 wt. % to less than or equal to about 10 wt. %, optionally greater than or equal to about 0.01 wt. % to less than or equal to about 10 wt. %, and in certain aspects, optionally greater than or equal to about 0.01 wt. % to less than or equal to about 5 wt. %, of the conductive oxygen storage material.

In each variation, as a particle coating 210, 410 and/or a layer coating 312, 412, the conductive oxygen storage material includes an oxygen storage material having a lithium-ion diffusion coefficient greater than or equal to about 10-15 cm²·s, and in certain aspects, optionally greater than or equal to about 10-15 cm²·s to less than or equal to about 10⁻⁵ cm²·s. For example, in certain variations, the conductive oxygen storage material may include lithium cerium oxide (Li₂CeO₃), lithium cerium phosphate (Li₂Ce(PO₄)₂), lithium cerium halide (LiCeX₅, where X is F, Cl, Br, I, and/or the like), lithium cerium sulfate (Li₂Ce(SO₄)₃), lithium cerium nitrate (Li₂Ce(NO₃)₆), or any combination thereof. Although certain oxygen storage materials, like cerium oxide (CeO₂), can help to improve the stability of the positive electroactive material, such materials generally have low lithium-ion conductivity (e.g., less than about 10-15 cm²·s), which can hinder the lithium transfer pathway and result in a significant capacity loss. The addition of the lithium compounds improves the lithium-ion conductivity of the oxygen storage materials and facilitates charge transfer.

With renewed reference to FIG. 1, in each variation, the positive electroactive material may also be optionally intermingled with an electronically conductive material (i.e., conductive additive) that provides an electron conductive path and/or a polymeric binder material that improves the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the positive electrode 24 may be the same as or different from the conductive additive as included in the negative electrode 22.

In various aspects, the present disclosure provides methods for preparing conductive oxygen storage material coatings or layers, like the particle coatings 210, 410 illustrated in FIGS. 2 and 4, respectively, and/or the layer coatings 312, 412 illustrated in FIGS. 3 and 4, respectively. The methods may include contacting a precursor oxygen storage material with a plurality of electroactive material particles and/or a layer including a plurality of electroactive material particles to form a first admixture. The precursor oxygen storage material may include, for example, ceric ammonium nitrate, cerium nitrate, cerium acetate, cerium hydroxide, cerium chloride, cerium acetylacetonate hydrate, cerium tri(methylsilyl)amide, cerium tetrakis(diisopropylamide). The solvent or surfactant may include, for example, water, 1-octadecene, oleylamine, oxalic acid, diphenyl ether, oleic acid, cetyltrimethyl ammonium bromide, octadecylamine, 1,2-hexadecanediol, polyethylene glycol, and/or combinations thereof. In certain variations, the contacting may include mixing together, for example using magnetic stirring, the precursor oxygen storage material and the plurality of electroactive material particles to form the first admixture.

In certain variations, the methods may further include contacting a precipitate to the first admixture. The precipitant may help to precipitate the precursor oxygen storage material onto surfaces of the precursor positive electroactive material. In certain variations, the precipitant may be contacted to the admixture using a drop wise process. The precipitant may include, for example, sodium hydroxide, ammonium hydroxide, ammonium bicarbonate, potassium carbonate, sodium carbonate, poly(vinylpyrrolidone), citric acid, trisodium phosphate dodecahydrate, dithio-polydopamine, 1,4-butanediol, ethylenediamine, ethylene glycol, methanol, folic acid, tetrabutyl ammonium hydroxide, or any combination thereof.

In certain variations, the method may further include contacting a lithium precursor to the first admixture including the precipitant to form a second admixture and sintering the second admixture at a temperature greater than or equal to about 300° ° C. to less than or equal to about 1,000° ° C., and in certain aspects, optionally about 600° C., for a period greater than or equal to about 1 hour to less than or equal to about 10 hours, and in certain aspects, optionally about 5 hours, to form the electroactive material including the conductive oxygen storage material coatings or layers. The lithium precursor may include, for example, one or more lithium salts (e.g., LiOH, Li₂CO₃, LiNO₃, LiPF₆), lithium nitrides, lithium hydride, lithium halides, perovskite-type structures (e.g., lithium lanthanum titanate (LLTO)), garnet-type structures (e.g., lithium lanthanum zirconate (LLZO)), lithium argyrodites (e.g., Li₂P₃S₁₁ (LPS)), lithium superionic conductors (e.g., LinAlP₂S₁₂ (LISICON)-type structures), thio-LISICON-type structures, thiophosphates (e.g., Li₁₀GeP₂S₁₂ (LGPS)), sodium superionic conductor (e.g., Na_{3.1}Zr_{1.95}Mg_{0.05}Si₂PO₁₂ (NASICON)-type structures), and combinations thereof.

In other variations, the conductive oxygen storage material coatings or layers, like the particle coatings 210, 410 illustrated in FIGS. 2 and 4, respectively, and/or the layer coatings 312, 412 illustrated in FIGS. 3 and 4, respectively, may be prepared using methods like those detailed in U.S. application Ser. No. 18/094,145, titled “Nickel-Rich Electroactive Materials”, filed on the same day herewith, and naming Zhongyi Liu, Mengyuan Chen, Bradley R. Frieberg, Xiaosong Huang, Ratandeep Singh Kukreja, Nicholas Paul William Pieczonka, the entire disclosure of which is hereby incorporated by reference.

Certain features of the current technology are further illustrated in the following non-limiting examples.

### EXAMPLE 1

Example batteries and battery cells may be prepared in accordance with various aspects of the present disclosure.

For example, a first example cell 510 may include a first positive electroactive material layer including one or more conductive oxygen storage material coatings or layers. For example, the first positive electroactive material layer may include a nickel-rich positive electroactive material (e.g., LiNi_{1-x-y-z}CoₓMn_{y}Al₂O₂ (where 0.02≤x≤0.20, 0.01≤y≤0.12, 0.01≤z≤0.08) (NCMA), which comprises greater than or equal to about 80 molar % of nickel) and one or more conductive oxygen storage material coatings or layers including Li₂CeO₃.

A first comparative cell 520 may include a second positive electroactive material layer including one or more oxygen storage material coatings or layers. For example, the second positive electroactive material layer may include the nickel-rich positive electroactive material (e.g., LiNi_{1-x-y-z}CoₓMn_{y}Al₂O₂ (where 0.02≤x≤0.20, 0.01≤y≤0.12, 0.01≤z≤0.08) (NCMA), which comprises greater than or equal to about 80 mass % of nickel) and one or more conductive oxygen storage material coatings or layers including CeO₃.

A second comparative cell 530 may include a third positive electroactive material layer. The third positive electroactive material layer may include the nickel-rich positive electroactive material (e.g., LiNi_{1-x-y-z}CoₓMn_{y}Al₂O₂ (where 0.02≤x≤0.20, 0.01≤y≤0.12, 0.01≤z≤0.08) (NCMA), which comprises greater than or equal to about 80 mass % of nickel).

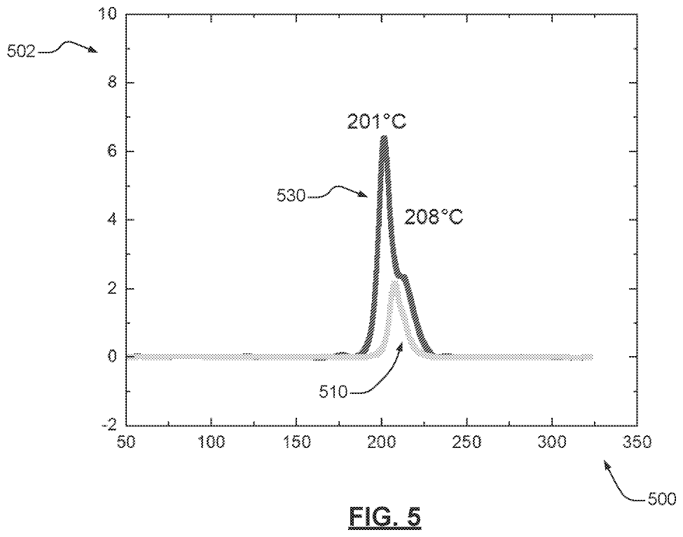

FIG. 5 is a graphical illustration representing the thermal stability of the example cell 510 as compared to the second comparative cell 530, where the x-axis 500 represents temperature (° C.), and the y-axis 502 represents heat flow (mW/mg). As illustrated, the example cell 510 including the one or more conductive oxygen storage material coatings or layers has improved thermal stability. For example, the example cell 510 may have a heat reduction of about 55% and a heat release peak temperature delay of about 7° C. Further, the first comparative cell 520 may have about 80% of the capacity of the second comparative cell 530, while the example cell 510 has about 100% of the capacity of the second comparative cell 530.

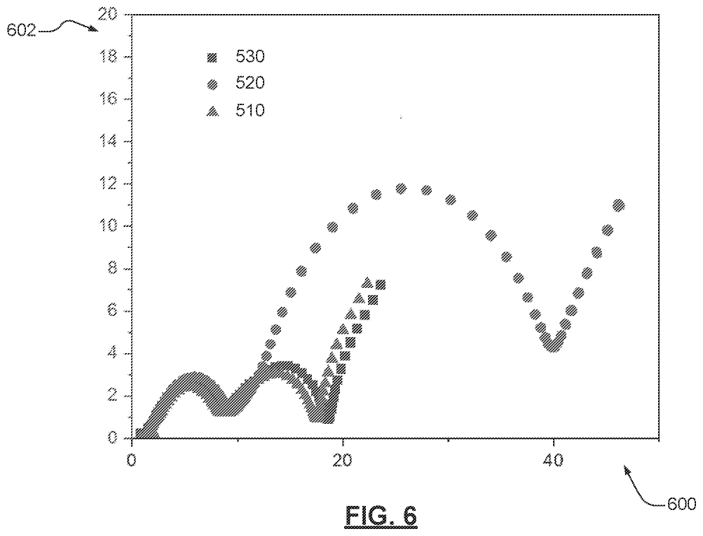

FIG. 6 is a graphical illustration representing the resistance of the example cell 510 as compared to the first and second comparative cells 520, 530, where the x-axis 600 represents Re(Z)/Ohm, and the y-axis 602 represents -Im(Z)/Ohm. As illustrated, the first comparative cell 520 has a higher charge transfer resistance (e.g., 16.21), while the example cell 510 has a lower charger transfer resistance (e.g., 5.67), However, the first comparative cell 520 has lower lithium solid diffusivity (e.g., 1.19E-11), while the example cell 510 has a high solid diffusivity (e.g., 2,15E-11). By way of comparison, the second comparative cell 530 may have a charger transfer resistance of about 5.77, and a lithium solid diffusivity of about 2.01E-11.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electroactive material for an electrode of an electrochemical cell, the electroactive material comprising:
a plurality of electroactive material particles, at least a portion of the plurality of electroactive material particles having a coating comprising a conductive oxygen storage material having a lithium diffusion coefficient greater than or equal to about 10⁻¹⁵ cm²·s.

2. The electroactive material of claim 1, wherein the electroactive material comprises greater than 0 wt. % to less than or equal to about 10 wt. % of the plurality of electroactive material particles having the coating.

3. The electroactive material of claim 1, wherein the conductive oxygen storage material is selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

4. The electroactive material of claim 1, wherein the electroactive material particles comprise a nickel rich electroactive material represented by: 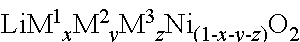
where M¹, M², and M³ are each a transition metal independently selected from the group consisting of: manganese (Mn), cobalt (Co), aluminum (Al), iron (Fe), and combinations thereof, where 0≤x≤1, 0≤y≤1, and 0≤z≤1 and 1-x-y-z is greater than 0.6.

5. The electroactive material of claim 1, wherein the coating is a continuous coating covering greater than or equal to about 85% of a total surface area of the respective electroactive material particles.

6. The electroactive material of claim 1, wherein the coating has an average thicknesses greater than 2 nanometers to less than or equal to about 200 nanometers.

7. An electrode for an electrochemical cell, the electrode comprising:
an electroactive material layer comprising a plurality of electroactive material particles; and
a conductive layer comprising an oxygen storage material and having a lithium diffusion coefficient greater than or equal to about 10-15 cm²·s disposed on one or more surfaces of the electroactive material layer.

8. The electroactive material of claim 7, wherein the electrode comprises greater than 0 wt. % to less than or equal to about 10 wt. % of the oxygen storage material.

9. The electroactive material of claim 7, wherein the oxygen storage material is selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

10. The electroactive material of claim 7, wherein the electroactive material particles comprise a nickel rich electroactive material represented by: 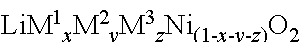
where M⁴ is nickel and M¹, M², and M³ are each a transition metal independently selected from the group consisting of: manganese (Mn), cobalt (Co), aluminum (Al), iron (Fe), and combinations thereof, where 0≤ x≤1, 0≤ y≤1, and 0≤ z≤1 and 1-x-y-z is greater than 0.6.

11. The electroactive material of claim 7, wherein the conductive layer is a continuous layer covering greater than or equal to about 85% of a total surface area of the respective surfaces of the electroactive material layer.

12. The electroactive material of claim 7, wherein the conductive layer has an average thickness greater than 2 nanometers to less than or equal to about 200 nanometers.

13. The electroactive material of claim 7, wherein the oxygen storage material is a first oxygen storage material and at least a portion of the plurality of electroactive material particles are coated with a second oxygen storage material.

14. The electroactive material of claim 13, wherein the second oxygen storage material defines particle coatings on the portion of the electroactive material particles, wherein the particle coatings have average thicknesses greater than 2 nanometers to less than or equal to about 200 nanometers.

15. The electroactive material of claim 13, wherein second oxygen storage material defines particle coatings on the portion of the electroactive material particles, wherein the particle coatings are continuous coatings covering greater than or equal to about 85% of a total surface area of the respective electroactive material particles.

16. The electroactive material of claim 13, wherein the second oxygen storage material is selected from the group consisting of: lithium cerium oxide (Li₂CeO₃), lithium cerium phosphate (Li₂Ce(PO₄)₂), lithium cerium halide (LiCeX₅, where X is selected from the group consisting of: P, Cl, Br, I, and combinations thereof), lithium cerium sulfate (Li₂Ce(SO₄)₃), lithium cerium nitrate (Li₂Ce(NO₃)s), and combinations or derivatives thereof.

17. The electroactive material of claim 13, wherein the second oxygen storage material is the same as the first oxygen storage material.

18. An electrode for an electrochemical cell, the electrode comprising:
an electroactive material layer comprising a plurality of electroactive material particles,
wherein the electroactive material particles of the plurality comprise a nickel rich electroactive material represented by: 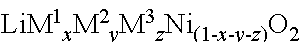
where M¹, M², and M³ are each a transition metal independently selected from the group consisting of: manganese (Mn), cobalt (Co), aluminum (Al), iron (Fe), and combinations thereof, where 0<<<1, 0<y≤1, and 0<z≤1 and 1-x-y-z is greater than 0.6, and
wherein at least a portion of the plurality of electroactive material particles comprise a particle coating comprising a first conductive oxygen storage material, and a conductive layer comprising a second conductive oxygen storage material is disposed on one or more surfaces of the electroactive material layer, the first and second conductive oxygen storage materials each having a lithium diffusion coefficient greater than or equal to about 10-15 cm²·s.

19. The electrode of claim 18, wherein the first and second conductive oxygen storage materials are selected from the group consisting of: lithium cerium oxide (Li₂CeO₃), lithium cerium phosphate (Li₂Ce(PO₄)₂), lithium cerium halide (LiCeX₅, where X is selected from the group consisting of: F, Cl, Br, I, and combinations thereof), lithium cerium sulfate (Li₂Ce(SO₄)₃), lithium cerium nitrate (Li₂Ce(NO₃)₆), and combinations or derivatives thereof.

20. The electrode of claim 18, wherein the electrode comprises less than or equal to about 10 wt. % of the first conductive oxygen storage material, and less than or equal to about 10 wt. % of the second conductive oxygen storage material.
